(19) United States
(12) Patent Application Publication
(10) Pub. No.: US 2002/0051554 A1
(43) Pub. Date: May 2, 2002

(54) Hands-free device

(76) Inventors: Klaus Rodemer, Lautertal (DE); Joerg Ohlenburger, Braunfels (DE)

Correspondence Address: Iandiorio & Teska, 260 Bear Hill Road, Waltham, MA, 02451-1018, US

(21) Appl. No.: 10/002,666

(22) Filed: Oct. 31, 2001

(30) Foreign Application Priority Data
Oct. 31, 2000 (DE) 100 54 118.6

(51) Int. Cl. H04B 1/38; H04R 25/00

(52) U.S. Cl. 381/370; 381/374; 381/375; 455/90

(57) ABSTRACT

In a hands-free device which is particularly suited for automotive vehicles, the loudspeaker (20) is arranged in a housing (16) which is loosely seated on the belt and which is fixed with a mounting to the B-pillar near the ear. The microphone (30) is positioned within a microphone housing (18) which can be displaced on and fixed to the belt (10), and communicates via an infrared path with a circuit provided in the loudspeaker housing. An accumulator which powers the microphone circuit is charged via charging contacts (34, 36) between microphone housing and loudspeaker housing when the microphone housing (18) is pushed towards the loudspeaker housing (16). Power can be supplied via a cable from the car socket, and the signal transmission between free-hands device and mobile telephone takes place via a plug connection with the head-set jack of the telephone.

The present invention relates to a hands-free device comprising the features indicated in the preamble of claim 1.

It is known from DE 38 08 055 A1 that the microphone of a hands-free device is accommodated in a microphone housing which is displaceable on the safety belt, so that it can be brought into an acoustically advantageous position on the chest area of the driver, so that the driver need not take away his/her hands from the steering wheel when making a telephone call. The remaining part of the hands-free device can be installed at any suitable place in the vehicle and may either have a loudspeaker of its own or may be connected to the car radio.

It is the object of the present invention to provide a complete hands-free device which can easily be installed into a vehicle also at a later time and is suited for direct connection to a mobile telephone used in the vehicle in which case both the microphone and the loudspeaker can be positioned for optimum speech distinctness or intelligibility without any acoustic feedback having to be feared during normal operation.

This object is achieved with the features indicated in claim 1. Developments of the invention are characterized in the subclaims.

Since both the microphone and the loudspeaker are mounted on the safety belt, it is possible to position the loudspeaker in the shoulder area near the ear, resulting in a high intelligibility—also in the case of noisy surroundings—at a relatively small loudspeaker power. To this end the loudspeaker housing may e.g. be fixed to the upper deflection point of the safety belt by means of a suitable fastening device, so that the loudspeaker is positioned as closely as possible near the ear. Thanks to today's standard height-adjusting possibility of the belt deflection for differently tall drivers, the position of the loudspeaker is then equally changed, so that it always remains in an advantageous position near the ear even in the case of different drivers. For mounting the microphone housing on the belt deflection—on the B-pillar of an automotive vehicle—a sufficiently stiff piece of cable or a cable sleeve may e.g. be used via which the power supply lines and signal lines are guided to the loudspeaker housing. When the belt is extended or rolled up, it freely runs through a guide means of the loudspeaker housing which during this operation remains at its fixed distance from the belt deflection.

The microphone housing which is displaceable on the belt permits the selection of an advantageous position near the mouth, the microphone being expediently provided at the housing side facing the head in order to receive sound waves from the mouth as directly as possible. The connection of the microphone circuit from the microphone housing to the circuit in the loudspeaker housing is expediently established via an infrared path in the case of which a modulative light-emitting diode is arranged at the side of the microphone housing facing the loudspeaker housing and a suitable photosensor is provided in the loudspeaker housing to face the light-emitting diode. The microphone signals can thereby be transmitted to the circuit in the loudspeaker housing.

An accumulator contained in the microphone housing expediently serves to power the microphone circuit, the accumulator being chargeable via charging contacts from the loudspeaker housing when the microphone housing is slid towards the loudspeaker housing provided with respective cooperating contacts. The necessary contact pressure is conveniently ensured by a magnetic coupling provided between the two housings, the coupling consisting of a magnet in the one housing and of an armature in the other housing, so that the two housings are held on each other when slid together.

For fixing the microphone housing in an advantageous speech position, a locking device is expediently provided for fixing the microphone housing on the belt to such a degree that it does not move of itself. The lock can be released when the microphone housing is pushed towards the loudspeaker housing so that only the magnetic forces of the coupling define the contact pressure of the charging contacts. To achieve this state automatically, the part of the coupling provided in the microphone housing may be retractable and extensible in the manner of the bolt of a door lock and may be coupled to the locking mechanism such that it is pushed thereinto and releases the lock when the microphone housing is pushed towards the loudspeaker housing.

The present invention is particularly suited for retrofitting purposes when a free-hands system has not already been installed in an automotive vehicle by the manufacturer. Only microphone housing and loudspeaker housing have to be arranged on the safety belt; the power connection can be established from the loudspeaker housing via a cable with a plug of the car socket in which the cigarette lighter is normally inserted, while the signal connection with the cellular phone is established via the head-set jack thereof. Hence, no considerable efforts are needed for installing the free-hands device according to the invention in an automotive vehicle at a later time. As for the cellular phone itself, there are inexpensive universal mountings with which it can be accommodated within easy reach.

The invention shall now be explained in more detail with reference to an embodiment illustrated in the attached drawings, in which

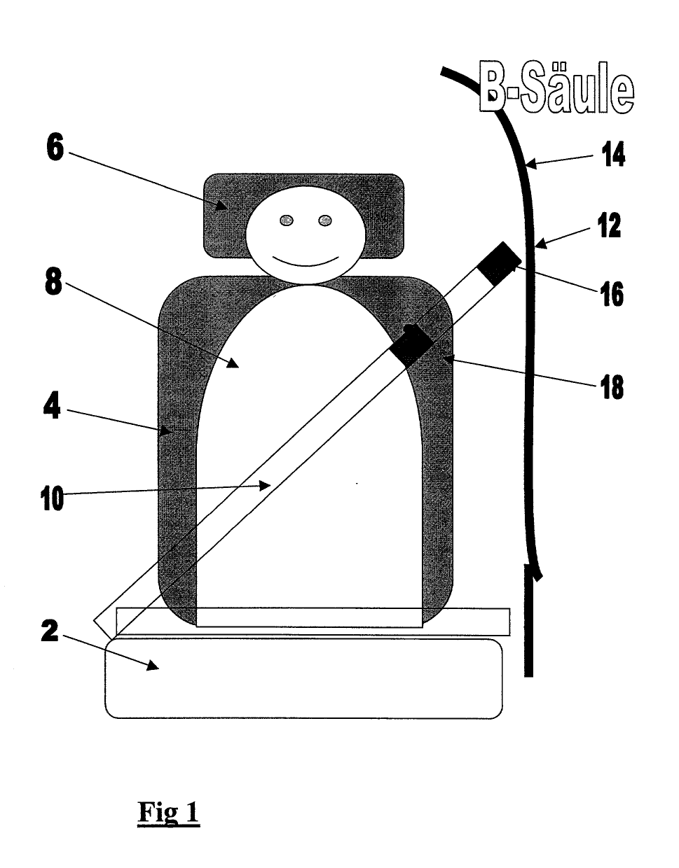

FIG. 1 is a schematic representation of a person sitting on a car seat and wearing a seat belt in the buckled-up state of the seat belt for illustrating the invention;

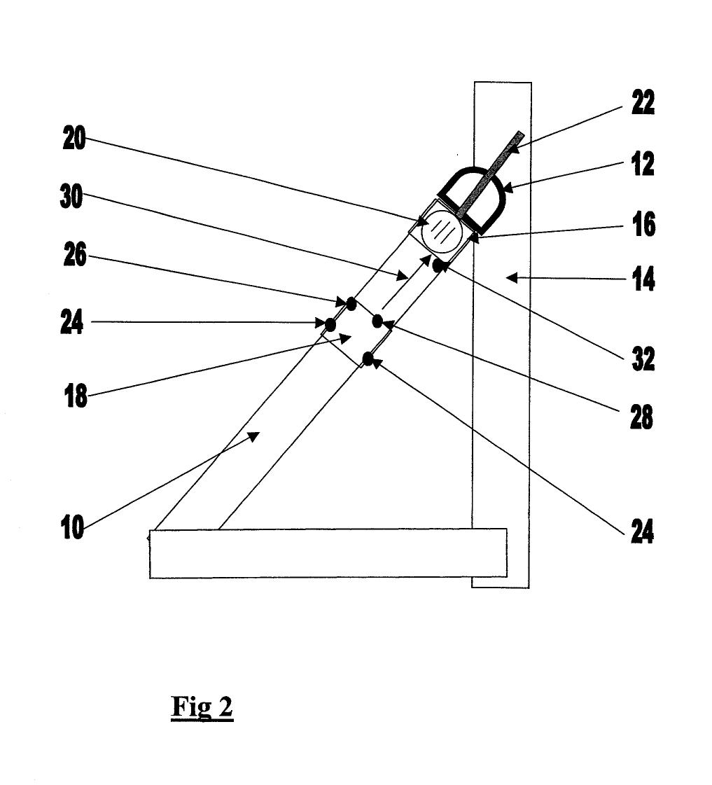

FIG. 2 is schematic illustration of a seat belt in the position of use with the hands-free device according to the invention;

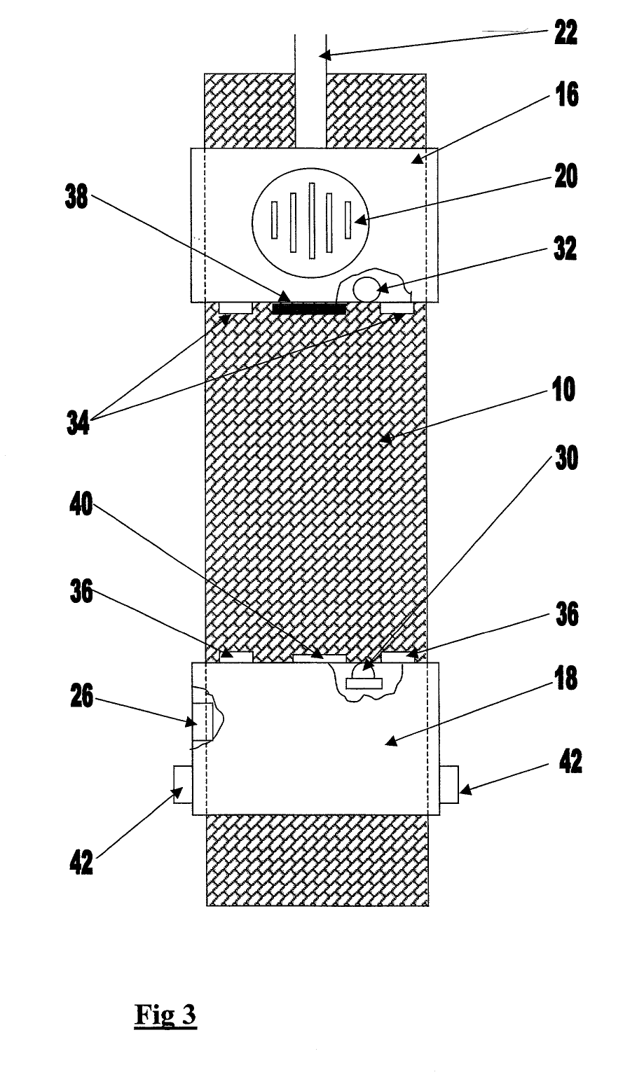

FIG. 3 is a detail drawing of the hands-free device mounted on a seat belt according to the present invention.

FIG. 1 illustrates a car seat 2 with a back 4 and a headrest 6 as well as a person 8 illustrated in a sitting position and wearing a seat belt 10. Said seat belt extends in the standard way across the pelvis and obliquely over the chest up to a deflection point 12 on the B-pillar 14 of an automotive vehicle. A loudspeaker housing 16 of the hands-free device through which the belt 10 can run when being rolled up or unrolled is seated near the deflection point 12. The loudspeaker housing 16 itself is anchored in a suitable way on or near the deflection point 12 so that the loudspeaker contained therein has an advantageous position relative to the ear of person 8. A microphone housing 18 is movably seated on belt 10 and can be slid into a position which is advantageous with respect to the mouth of person 8 and in which it remains locked in place by a suitable locking mechanism. Such a locking need only be so firm that the microphone does not move of its own on the belt, whereas an intended displacement is definitely allowed by the locking.

FIG. 2 illustrates the safety belt 10 in the fastened position without person and car seat for a better illustration of the loudspeaker housing 16 and the microphone housing 17 on the belt. A loudspeaker 20 is positioned within the loudspeaker housing 16, and in the illustrated example the housing 16 is held by a relatively stiff cable piece 22 in such a position in the area of the B-pillar 14 that the loudspeaker 20 is positioned as near as possible relative to the ear of person 8. The sound waves can thus travel from the loudspeaker to the ear over the shortest distance possible, and the loudspeaker power need not be high for achieving a high speech intelligibility. The loudspeaker housing 16 is provided on its back with a guide means for the belt 10, for instance in the form of cheeks gripping over the belt on both sides, so that, on the one hand, the housing can be easily mounted on the belt and, on the other hand, the belt can run through the housing guide means without being hindered when being rolled up or unrolled.

The microphone housing 18 may comprise a similar guide means to be easily mountable on the belt also at a later time. Moreover, there is provided a clamping or locking mechanism which can be operated via two push-buttons 24 to protect the microphone housing from unintended slippage on the belt. At the side of the microphone housing 18 facing the head of person 8, the microphone 26 is arranged, so that it is oriented towards the person's mouth and directly receives his/her words. Such an arrangement of microphone and loudspeaker results in an extremely low acoustic feedback, so that no singing noise need be feared. If necessary, a further decoupling can be achieved through additional circuit measures, such as filters, etc., so that a simultaneous two-directional operation is easily possible.

In the illustrated embodiment, the microphone signals control a light-emitting diode 28 which permits the transmission of modulated infrared rays 30 to a photosensor 32 provided in the loudspeaker housing 16, with a suitable amplifier being arranged downstream of said photosensor.

FIG. 3 shows the arrangement of said elements in the respective housings 16 and 18 more clearly: These are protectively accommodated within the respective housing and arranged behind corresponding sound- and light-transmitting orifices or windows which are here not illustrated in detail. Power is supplied to the amplifier in the loudspeaker housing 16 via cable 22. The power supply of the circuit positioned in the microphone housing 18 is used for a chargeable battery which in the inoperative state of the hands-free device is recharged from the loudspeaker housing 16 via charging contacts 34, 36. The charging contacts 34 and 36 are arranged at sides of loudspeaker housing 16 and microphone housing 18 that face each other, so that they rest on each other when the housings are pushed together, the desired contact pressure being produced with the help of a magnet 38 and an armature 40 which are provided in the loudspeaker housing 16 and on the microphone housing 18, or reversely.

In a special design of the invention, the armature 40 can be pushed out of the microphone housing 18 like the bolt of a door lock when the two lateral locking buttons 42 are pressed with the help of which the microphone housing 18 can be stopped in a desired position on the belt 10, so that it does not move unintentionally. When in the inoperative position the microphone housing 18 is pushed towards the loudspeaker housing 16, the armature 40 will come to rest on magnet 38 and will be slid into the microphone housing 18, the locking being released due to a mechanical coupling of the armature 40 with the locking device, and the contacts 34 and 36 being allowed to freely contact each other without being impeded by the locking, and the contact pressure being defined by the magnetic forces between magnet 38 and armature 40. When rolled up, the belt 10 can freely run through the guide means of housings 16 and 18, and in the rolled-up state of the belt the microphone housing 18 is suspended from the side of the B-pillar such that it is magnetically held on the loudspeaker housing 16, and the battery in the microphone housing 18 can be recharged. When the belt is fastened, the microphone housing 18 is pulled downwards towards the chest area and the two locking buttons 42 are pressed to fix it in the desired position on the belt. As has been stated, this fixation is only so firm that the microphone can still be displaced intentionally to correct the position.

1. A hands-free device comprising a microphone and a loudspeaker, in particular for automotive vehicles or the like with seat belts, in which said microphone is arranged in a housing slidably disposed on the belt and can be brought into a speech position and locked, in the fastened state of said belt, characterized in
that said loudspeaker (20) is also arranged in a housing (16) which is loosely seated on said belt (10) and which is positioned via a mounting fastened in the area of an upper belt deflection (12) in such a manner that said loudspeaker (20) is positioned near the ear, in the fastened state of said belt.

2. The hands-free device according to claim 1, characterized by an infrared connection (30) for transmitting microphone signals from said microphone housing (18) to an electric circuit of said hands-free device in said loudspeaker housing (16).

3. The hands-free device according to claim 1, characterized in that there are provided, on said microphone housing (18) and on said loudspeaker housing (16), cooperating power supply contacts (34, 36), which, when said housings are pushed together, permit a charging current flow via said loudspeaker housing (16) to an accumulator in said microphone housing (18).

4. The hands-free device according to claim 1, 2 or 3, characterized in that said microphone housing (18) can be attached to said loudspeaker housing (16) via a magnetic coupling (38, 40).

5. The hands-free device according to claim 4, characterized in that said magnetic coupling is formed by a magnet (38) and an armature (40) which are arranged at facing sides of said housings (16, 18) and of which the part (40) provided on said microphone housing (18) can be extended or retracted and is coupled with a locking mechanism which is operable via push-buttons (42) and by which said microphone housing (18) can be locked or released on said belt (10).

6. The hands-free device according to claim 1, characterized in that said mounting is formed by a sufficiently stiff piece of cable (22) via which the electrical components in said loudspeaker housing (16) are connected to the power supply and the remaining circuit.

7. The hands-free device according to any one of the preceding claims, characterized in that the power supply line is provided with a plug for a standard car socket (cigarette lighter) and the signal line is provided with a plug fitting the head-set jack of a mobile telephone.
